(19) United States
(12) Patent Application Publication
(10) Pub. No.: US 2011/0193522 A1
(43) Pub. Date: Aug. 11, 2011

(54) OPERATION MANAGING SERVER FOR CHARGING STATIONS AND OPERATION MANAGING SYSTEM FOR CHARGING STATIONS

(75) Inventor: Kenichiro UESUGI, Moriya-shi (JP)

(73) Assignees: Motion Co., Ltd., Tokyo (JP); Kanematsu Communications Limited, Tokyo (JP); Kanematsu Corporation, Kobe-shi (JP)

(21) Appl. No.: 13/020,183

(22) Filed: Feb. 3, 2011

(30) Foreign Application Priority Data
Feb. 5, 2010 (JP) 2010-024465

(51) Int. Cl. H02J 7/00

(52) U.S. Cl. 320/109

(57) ABSTRACT

An operation managing server for charging stations each of which has a charger and accepts a charging request for charging a vehicle battery of a user through the charger at a charging station, including a charging request accepting unit that accepts a charging request from a user when the user makes the charging request, and a charging time estimating unit that estimates a charging time required to charge the vehicle battery of the user on the basis of past charger using data of the user, wherein when there is any charging request from a next user, the charging request accepting unit accepts the charging request concerned while reflecting the estimated charging time of the former user.

### INCORPORATION BY REFERENCE

The present application claims priority under 35 U.S.C. §119 to Japanese Patent Application No. 2010-024465 filed on Feb. 5, 2010. The content of the application is incorporated herein by reference in its entirety.

### BACKGROUND OF THE INVENTION

1. Field of the Invention

The present invention relates to an operation managing server for charging stations and an operation managing system for charging stations.

2. Description of Related Art

There is known a charging station for charging an electric vehicle which has a battery for driving a motor and runs while using electric power charged in the battery (for example, see JP-A-07-115732).

The charging station described in the above publication has a capacitor having a larger capacity than an in-vehicle mount battery, and the capacitor of the charging station is charged with electric power from a commercial power supply (grid) and also discharged to charge the in-vehicle mount battery.

Much time is taken to charge the battery of an electric vehicle, and thus there is a disadvantage that an electric vehicle cannot be immediately charged at a charging station when another vehicle is being charged at the charging station. Therefore, it is impossible to make an operation schedule for the electric vehicle.

In order to overcome the above disadvantage, a technique disclosed in JP-A-2003-262525 extracts charging stations (hereinafter referred to as “surrounding charging station(s)”) existing around the present position of an electric vehicle, and supplies information concerning the position(s) of the extracted surrounding charging station(s) and available information of a charger(s) set up in the charging station(s), whereby the user of the electric vehicle concerned is supplied with information concerning a charging station at which the user can start to charge the electric vehicle immediately or within a predetermined time after the electric vehicle arrives at the charging station.

According to the technique disclosed in JP-A-2003-262525, when a user of an electric vehicle utilizes a charging station immediately or within the predetermined time after the user's vehicle arrives at the charging station, a charging station(s) at which the waiting time for charging is shorter (or shortest) can be specified (recommended) on the basis of the current using states of the surrounding charging stations. However, a degradation condition affected by the performance, capacity, using termor using condition of the battery mounted in the electric vehicle, the residual capacity of the battery, etc. are not constant, and thus the charging time is not estimated in consideration of an individual condition of each battery.

Accordingly, even when the technique disclosed in JP-A-2003-262525 is applied to a system in which each user makes a request for use through a communication network such as the Internet or the like, it is impossible to map out a schedule such as future reservations, etc. in consideration of an actual state (charging state, degradation state, etc.) of a battery as a charging target. Therefore, when a schedule is arranged, it is necessary to arrange the schedule in good time, and there is a risk that the operation of charging stations cannot be efficiently performed.

Furthermore, more time is required to charge an electric vehicle as compared with a case where petroleum (gasoline) is supplied to an electric vehicle, and also a user may have to wait for utilization of a charging station during a transit period of propagation of charging stations or in a district in which a penetration rate is low or a district in which an utilization rate is excessively high. Still furthermore, in an unmanned operated charging station, a trouble may occur between a waiting user and a user who can preferentially use a charging station such as a charging reserving person or the like.

### SUMMARY OF THE INVENTION

Therefore, the present invention has been implemented in view of the foregoing situation, and has an object to provide an operation managing server for a charging station and an operation managing system for a charging station that can estimate a charging time more accurately, inform a waiting time accurately and manage a reservation schedule easily.

In order to attain the above object, according to a first aspect of the present invention, an operation managing server for charging stations each of which has a charger and accepts a charging request for charging a vehicle battery of a user through the charger at a charging station, comprises: a charging request accepting unit that accepts a charging request from a user when the user makes the charging request; and a charging time estimating unit that estimates a charging time required to charge the vehicle battery of the user on the basis of past charger using data of the user, wherein when there is any charging request from a next user, the charging request accepting unit accepts the charging request concerned while reflecting the estimated charging time of the former user.

According to the above server, when there is a charging request from a user, the server estimates a time required to charge a vehicle battery of the user on the basis of the past charger using data of the user concerned. Furthermore, when there is a charging request from a next user, the server accepts the charging request from the next user while reflecting the estimated time to estimation of a charging time for the next user.

Accordingly, the charging schedule of each charging station can be made more efficient, and also the effective waiting time of each user at each charging station can be reduced, so that the convenience for users can be enhanced and the operation efficiency of the charging stations can be enhanced.

In the above server, when there is any charging request from the next user, the charging request accepting unit presents a charging start allowance time to the next user on the basis of the estimated charging time and accepts the charging request from the next user.

According to the above server, the user who makes the charging request may go to a specified (or selected) charging station by the charging start allowance time at the latest. Therefore, it is unnecessary for the user to go to the charging station more early to wait for charging, and thus there occurs no traffic jam around the charging station.

In the above server, when the charging request accepting unit accepts a charging request containing a charging station which is selected and specified from plural charging stations by a user, the charging time estimating unit calculates waiting times of the user at the plural charging stations and presents a charging station bringing a shorter waiting time as a recommended charging station to the user.

Furthermore, in the above server, when the charging request accepting unit accepts the charging request containing the charging station which is selected and specified from the plural charging stations by the user, the charging time estimating unit calculates a distance from each of the plural charging stations to the specified charging station or a present position of the user and presents a charging station located at a shorter distance from the specified charging station or the present position of the user as a recommended charging station to the user.

According to the above server, the user can easily grasp the charging conditions at which the waiting times are shorter, and thus the user can suitably select the optimum charging station (i.e., the waiting time is shortest or the like), so that the convenience can be more greatly enhanced.

In the above server, the charging request is a request for reserving charging.

According to this server, when there is a charging reserving request from a user, the server estimates a time required to charge a vehicle battery of the user on the basis of the past charger using data of the user concerned. Furthermore, when there is a charging request (or reserving request) from a next user, the server accepts the charging request (reserving request) from the next user while reflecting the estimated time to estimation of a charging time for the next user.

According to a second aspect of the present invention, an operation managing system comprises: a plurality of charging stations each of which has a battery charger for charging a battery of an electric vehicle, and a controller for managing the battery charger; and a server that accepts a charging request for charging a battery of a user when the user makes the charging request to the server, has a data base for storing past charger using data of the user, and estimates a charging time required to charge the battery of the user on the basis of the past charger using data of the user.

According to the above operation managing system, when there is a charging request from a user, the server estimates a time required to charge a vehicle battery of the user on the basis of the past charger using data of the user concerned. Furthermore, when there is a charging request from a next user, the server accepts the charging request from the next user while reflecting the estimated time to estimation of a charging time for the next user.

Accordingly, the charging schedule of each charging station can be made more efficient, and also the effective waiting time of each user at each charging station can be reduced, so that the convenience for users can be enhanced and the operation efficiency of the charging stations can be enhanced.

In the above operation managing system, when there is a charging request from a next user, the server accepts the charging request from the next user while reflecting the estimated charging time of the former user.

Furthermore, the charging request is a request for reserving charging.

According to the above operation managing system, when there is a charging reserving request from a user, the server estimates a time required to charge a vehicle battery of the user on the basis of the past charger using data of the user concerned. Furthermore, when there is a charging request (or reserving request) from a next user, the server accepts the charging request (reserving request) from the next user while reflecting the estimated time to estimation of a charging time for the next user.

According to the present invention, the charging time can be more accurately estimated, the waiting time (or reservation time) can be more accurately informed to the user, the reservation schedule can be easily managed, the convenience of users can be enhanced, and the operation efficiency of charging stations can be enhanced.

### BRIEF DESCRIPTION OF THE DRAWINGS

FIG. 1 is a block diagram showing the construction of an operation managing system for charging stations according to an embodiment;

FIG. 2 is a diagram showing an example of a data format of a user data base;

FIG. 3 is a diagram showing an example of a data format of an accounting data base;

FIG. 4 is a diagram showing the construction of a use data base;

FIG. 5 is a flowchart showing user registration processing;

FIG. 6 is a sequence flowchart when a user makes a request for reservation and a request for waiting for charging;

FIG. 7 is a diagram showing an example of a reservation applying screen;

FIG. 8 is a diagram showing an example of a request screen for waiting for charging (charging waiting request);

FIG. 9 is a flowchart showing the processing of managing a schedule in the reservation processing;

FIG. 10 is a flowchart showing estimated charging time calculation processing;

FIG. 11 is a diagram showing an example of the reservation applying screen;

FIG. 12 is a diagram showing an example of a charging station reservation completing screen as an acceptance result screen;

FIG. 13 is a diagram showing an example of a charging waiting acceptance completion screen as an acceptance result screen;

FIG. 14 is a flowchart showing charging waiting processing;

FIG. 15 is a diagram showing the charging waiting processing;

FIG. 16 shows an example of a charging schedule in a charger of a charging station;

FIG. 17 is a flowchart showing feedback processing after charging is completed;

FIG. 18 is a diagram showing an example of a charging station use status screen;

FIG. 19 is a diagram showing an example of the reservation applying screen; and

FIG. 20 is a flowchart showing reservation processing.

### DETAILED DESCRIPTION OF PREFERRED EMBODIMENTS

Preferred embodiments according to the present invention will be described with reference to the accompanying drawings.

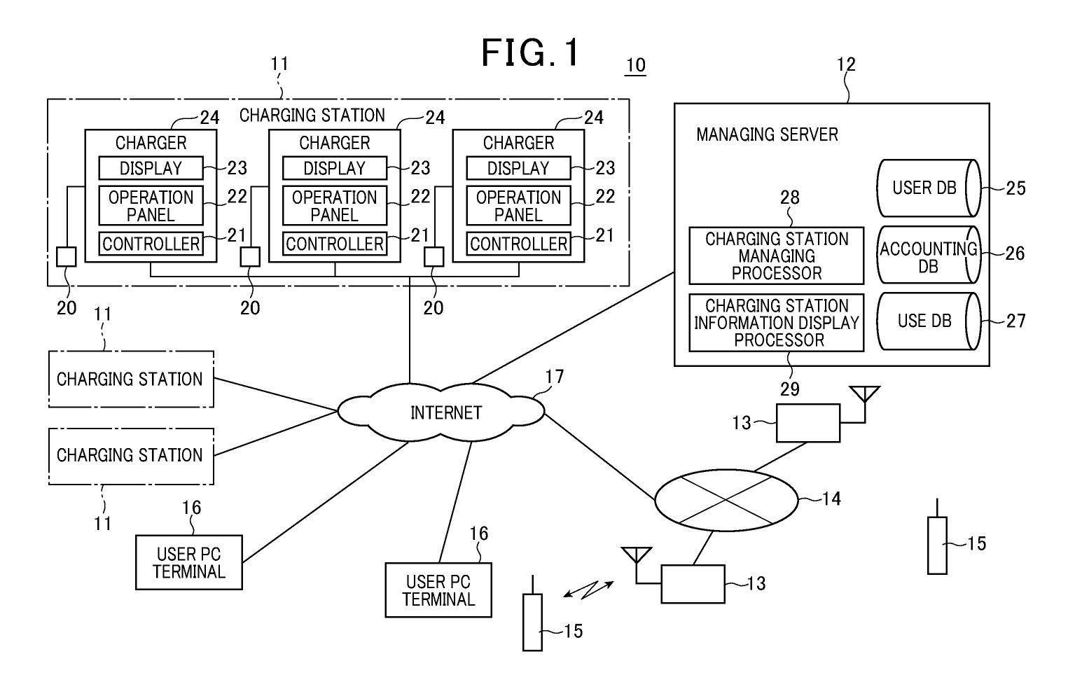

FIG. 1 is a block diagram showing the construction of an operation managing system for charging stations according to an embodiment.

An operation managing system 10 for charging stations mainly has plural charging stations 11, a managing server (operation managing server) 12, a telephone line network 14 to which plural base stations 13 are connected, plural portable telephone terminals 15 and plural user PC terminals 16.

In the operation managing system 10 for charging stations, the plural charging stations 11, the telephone line network 14, the plural portable telephone terminals 15 through the telephone line network 14, and the plural user PC terminals 16 are connected to the managing server 12 through the Internet 17 so as to perform communications.

Each charging station 11 has a charging connector 20 which is connected to an electrical vehicle (mainly a driving battery) in a charging operation to supply power to the electrical vehicle, and one or plural (three in the example of FIG. 1) chargers 24 each of which contains a controller 21, an operation panel 22 and a display 23.

The controller 21 is constructed as a microcomputer having a communication interface. The controller 21 has a communication function for performing communications through the Internet 17, a status detecting function for detecting a charging start timing, a charging finishing timing, a charged power amount or a trouble status of the charger, and a user authenticating function for performing user authentication for charging, and notifies, to the managing server 12, the status detected by the status detecting function and user authentication information obtained by the user authentication function.

Here, the status detecting function is implemented on the basis of the connection state of the charging connector 20, the measurement state of a power meter (not shown) or the detection status based on various kinds of sensors (not shown) (voltage sensor, current sensor, short-circuit sensor, etc.) provided to the respective parts of the charger 24.

The user authentication information is implemented by using user authentication information obtained by using a non-contact type IC card, a communication function of a portable telephone terminal or the like (for example, telephone number information transmitted from the telephone line network, password information input by a user or the like).

The managing server 12 has a user data base (DB) 25 in which user information is stored, an accounting data base (DB) 26 in which accounting information is stored, a use data base (DB) 27 in which data concerning use of charging stations by each user are stored, a charging station managing processor 28 for managing the charging stations 11 and a charging station information display processor 29 for performing charging station information display processing.

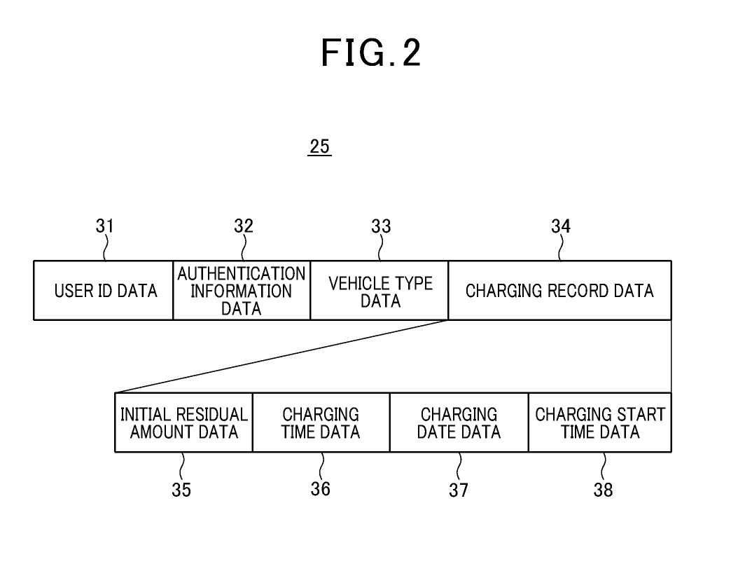

FIG. 2 is a diagram showing an example of the data format of the user data base.

The user data base 25 has user ID data 31 for specifying a user, authentication information data 32 for performing user authentication, vehicle type data 33 for specifying a battery as a charging target and a battery charging method (charging voltage, charging current, charging manner etc.) on the basis of the type of the user's vehicle, and charging record data 34 representing past charging records.

Here, the charging record data 34 has initial residual amount data 35 representing the residual amount of the battery when charging is started, charging time data 36 representing a time taken for charging, charging date data 37 representing a date on which charging is executed, and charging start time data 38 representing the charging start time.

An initial voltage of the battery or the like is used as the initial residual amount data 35. Furthermore, charging completing time data may be stored in place of the charging time data 36, whereby the charging time is calculated on the basis of the charging start time data 38 and the charging completion time data on a case-by-case basis.

In this embodiment, collection of a charging fee is performed by withdrawal from an account of a bank, payment based on a credit card, bank transfer based on issuance of a debit note or the like, and thus charging (accounting) data are required to be collected. Therefore, a charging (accounting) data base 26 is constructed in the managing server 12.

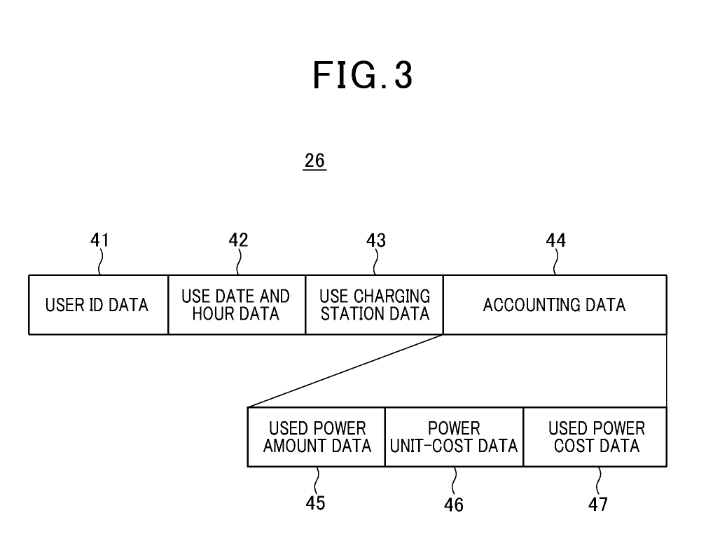

FIG. 3 is a diagram showing an example of the data format of the charging data base.

The charging data base 26 has user ID data 41 for specifying a user, a user date (date and hour) data 42 representing a date (date and hour) at which a charging station 11 is used, used charging station data 43 for specifying a used charging station 11, and accounting data 44.

Here, the accounting (charging) data has used power amount data 45 representing the amount of electrical power used for charging, power unit-cost data 46 representing a power unit cost at the time when the charging station 11 is used, and used power cost data 47 which is equal to the product between the used power amount data 45 and the power unit-cost data 46.

Here, when the power unit cost varies in accordance with season, the used power amount data 45 and the power unit-cost data 46 are stored every season to be discriminable among seasons.

With respect to the information required for actual accounting (charging) such as payment from a bank account or the like, these information is saved separately according to the same manner as described above.

Accordingly, charging money is calculated on the basis of the used power cost data 47 to be withdrawn from a bank account, and also a debit note containing a use report is mailed to each user monthly or it is made open at a site of the Internet so as to be accessible by each user.

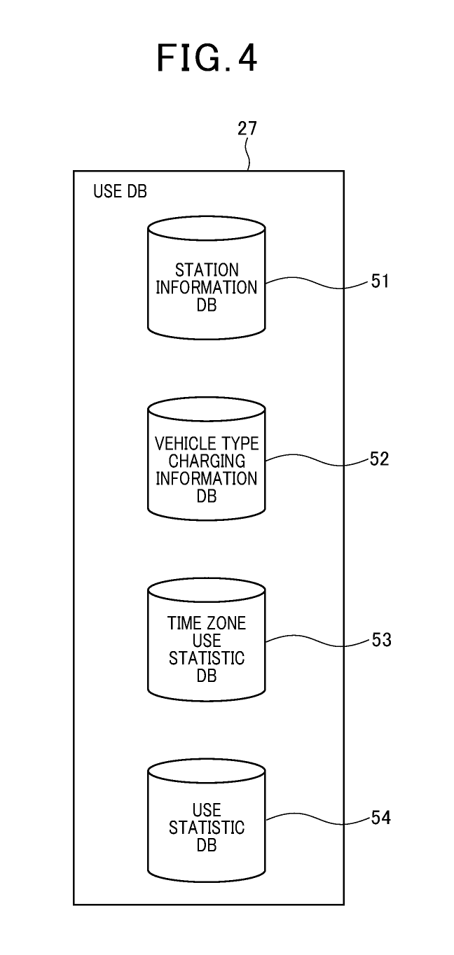

FIG. 4 is a diagram showing the construction of the use data base.

The user data base 27 comprises plural data bases, and it has a station information data base (DB) 51 for storing station information such as the locating position, the number of installed chargers, opening hour, opening date, etc. of each charging station and a charging schedule of each charging station (further each charger), a vehicle type charging information data base (DB) 52 in which an average charging time taken for once-charging every vehicle type is stored every one-day time zone, every day, every month, every season, etc., a time zone use statistic data base (DB) 53 for storing time zone use information such as a charging average time, etc. every time zone in each charging station, and a use statistic data base 54 for storing statistic data of the using condition of each registered user.

Here, the data of the charging average time (average time and standard deviation) of each one-day time zone, each day, each month, each season, each charging station, etc. for each registered user are stored in the use statistic data base 54. when the estimated charging time is greatly deviated from the charging average time, the estimated charging time is corrected and updated so as to approach to the charging average time.

Next, the user registration processing of allowing a person to use the operation managing system 10 (i.e., qualifying for use of the operation managing system 10) will be described. The user registration processing can be performed by using any one of the portable telephone terminal 15 and the user PC terminal 16. In the following description, a case where a new user accesses the managing server 12 through the user PC terminal 16 and the Internet 17 to register him/her will be described.

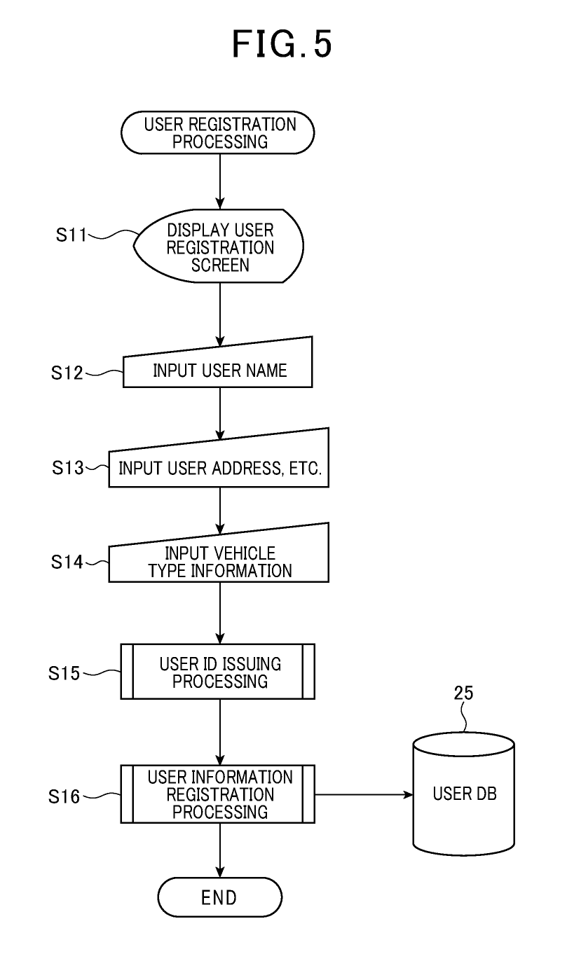

FIG. 5 is a flowchart showing the user registration processing.

When the new user accesses a new user registration page of the managing server 12 through his/her own user PC terminal 16 and the Internet 17, a new user registration screen is displayed on the display panel of a display (not shown) of the user PC terminal 16 (step S11).

The new user registration screen is provided with input columns for a user name, a user address, a portable telephone number, a password, etc., an input column for vehicle type information (vehicle type, manufacturing year, model number, etc.). A user inputs his/her name (step S12), inputs user's specific information such as user's address, etc. (step S13) and input vehicle type information (step S14).

Accordingly, the managing server 12 executes user ID issuing processing to display a new user registration completion screen, and displays the issued user ID on a predetermined user ID display window of the new user registration completion screen (step S15).

Subsequently, the managing server 12 stores the user information acquired from the user into the user DB 25 and then finishes the processing (step S16).

Next, the processing when a reservation request or a charging waiting request is made will be described.

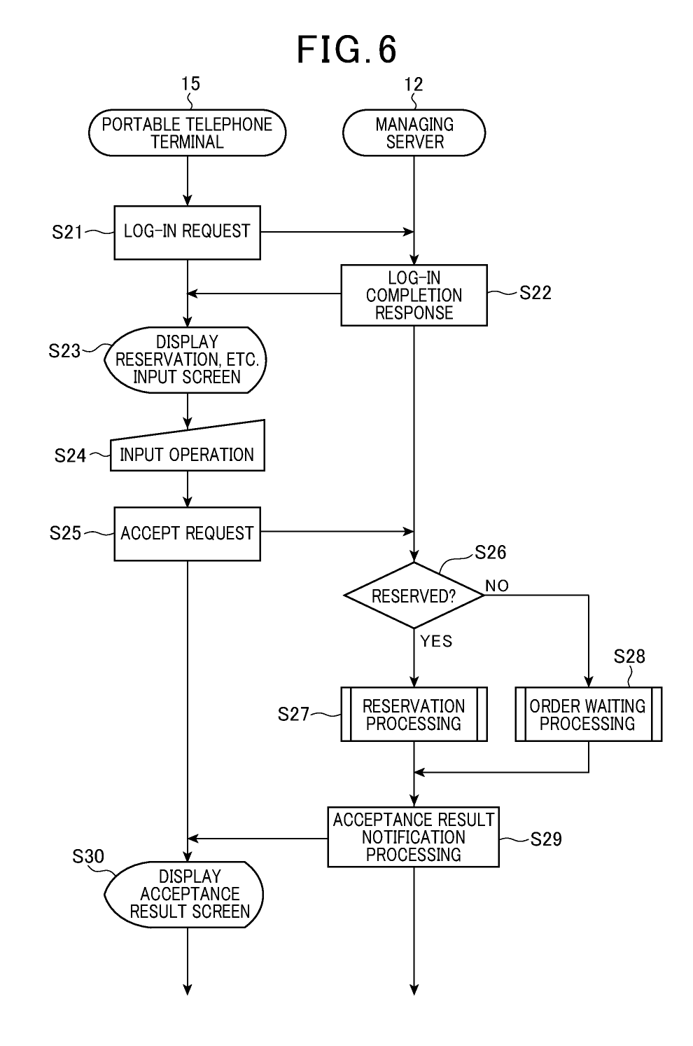

FIG. 6 is a sequence flowchart when the reservation request or the charging waiting request is made by a user.

The reservation request and the charging waiting request can be made by using any one of the portable telephone terminal 15 and the user PC terminal 16. However, in the following description, the processing when the reservation request or the charging waiting request is made to the managing server 12 through the portable telephone terminal 15 by a user will be described as an example.

First, the user operates the portable telephone terminal 15 to make a log-in request to the managing server 12 through the telephone line network 14 and the Internet 17 (step S21).

In this case, user ID issued in the user registration processing is used for the log-in request. Here, user authentication is made by using not only the user ID, but also portable telephone number information transmitted from the telephone line network 14 or the like at the managing server 12 side. When the log-in request is made from the user PC terminal 16, authentication information based on a third party such as portable telephone number information is not obtained, and thus it is necessary to input password information registered in the user registration processing.

When the log-in is completed, the managing server 12 makes a log-in completion response (step S22), and a reservation, etc. input screen is displayed on the display screen of the portable telephone terminal 15 (step S23). Accordingly, the user operates the operation unit to make a reservation request or a charging waiting request (step S24).

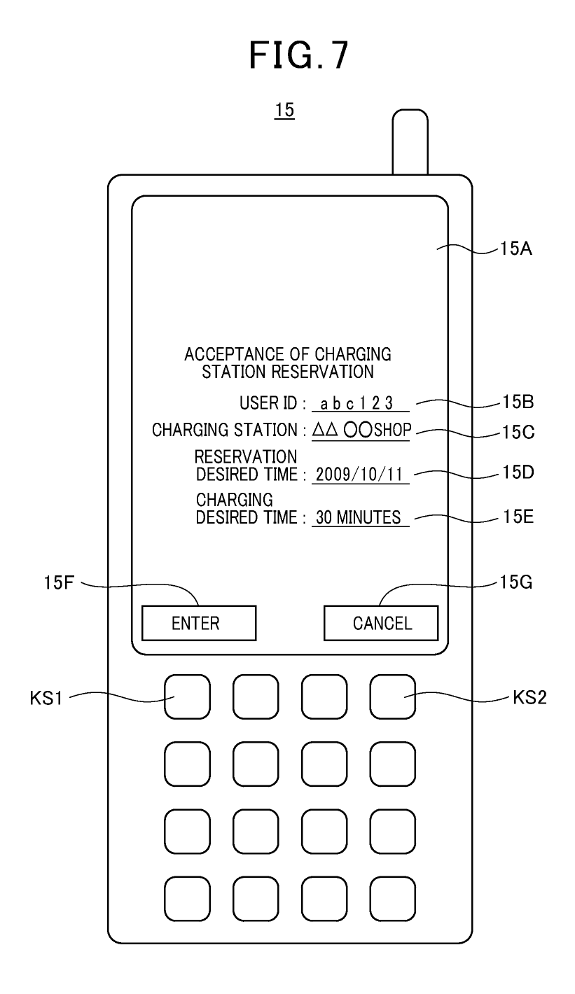

FIG. 7 is a diagram showing an example of a reservation acceptance screen.

The display screen 15A of the portable telephone terminal 15 has a user ID input column 15B, a charging station specifying column 15C, a reservation desired date input column 15d, a charging desired time input column 15E for inputting a charging desired time at which the user wants to charge, a first operation content display portion 15F representing that the operation of a key switch KS1 is an instruction of settling the content of a reservation request or a content being currently input, and a second operation content display portion 15G representing that the operation of a key switch KS2 is an instruction of cancelling the content of a reservation request or a content being currently input.

Specifically, in the case of the example of FIG. 7, user ID is “abc123”, a charging station which the user wants to reserve is “ΔΔ ◯◯ shop”, a reservation desired date is “Oct. 11, 2009”, and a charging desired time is “30 minutes”. In this case, the user makes a request for a reservation of a time zone in which charging is performed for 30 minutes on Oct. 11, 2009. When the input of the reservation acceptance screen is completed, the user checks the content thereof and then operates a key switch KS1. Accordingly, the reservation request content is settled (entered), and the acceptance request is transmitted to the managing server 12 side (step S25).

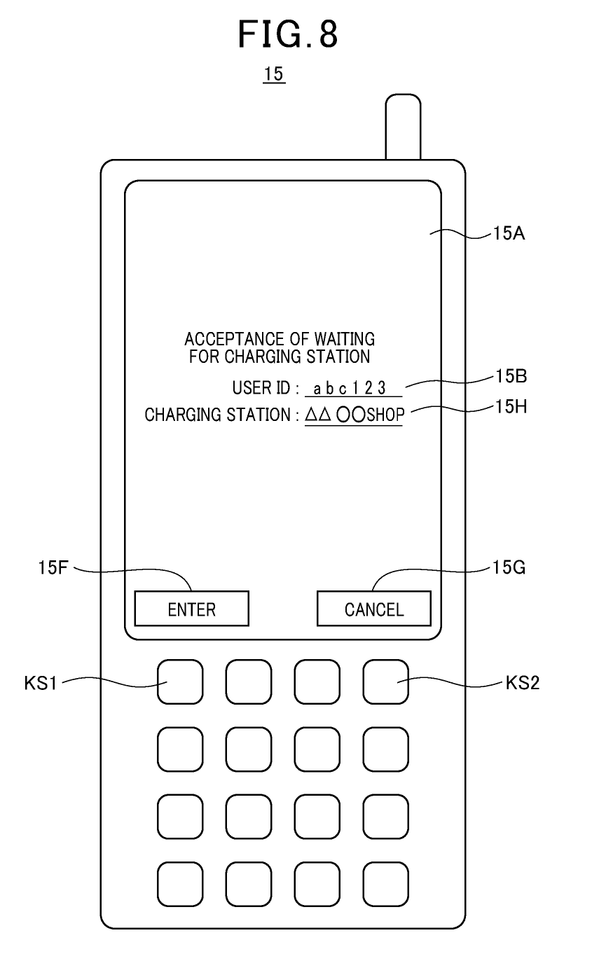

FIG. 8 is a diagram showing an example of a charging waiting request screen.

The display screen 15A of the portable telephone terminal 15 has a user ID input column 15B, a charging station indicating column 15H, a first operation content display portion 15F representing that the operation of the key switch KS1 is an instruction of settling (entering) the content of the charging waiting request or the content being currently input, and a second operation content display unit 15G representing that the operation of the key switch KS2 is an instruction of cancelling the content of the charging waiting request or the content being currently input.

Specifically, in the case of the example of FIG. 8, user ID is “abc123”, and a charging station 11 at which the user wants to wait for charging is “ΔΔ ◯◯ shop”.

When the input of the charging waiting request screen is input, the user checks the content thereof and then operates the key switch KS1.

Accordingly, the content of the charging waiting request is settled (entered) and the acceptance request corresponding to the charging waiting request is transmitted to the managing server side 12 (step S25).

Accordingly, when the managing server 12 receives the acceptance request corresponding to the reservation request or the charging waiting request, the managing server 12 determines whether the acceptance request concerned is associated with a reservation request or not (step S26).

It is determined in step S26 that the acceptance request concerned is associated with the reservation request (step S26; Yes), the processing is shifted to reservation processing (step S27). When the acceptance request concerned is associated with a charging waiting request, the processing is shifted to the waiting processing (step S28).

Next, the reservation processing described above (step S27) will be described in detail.

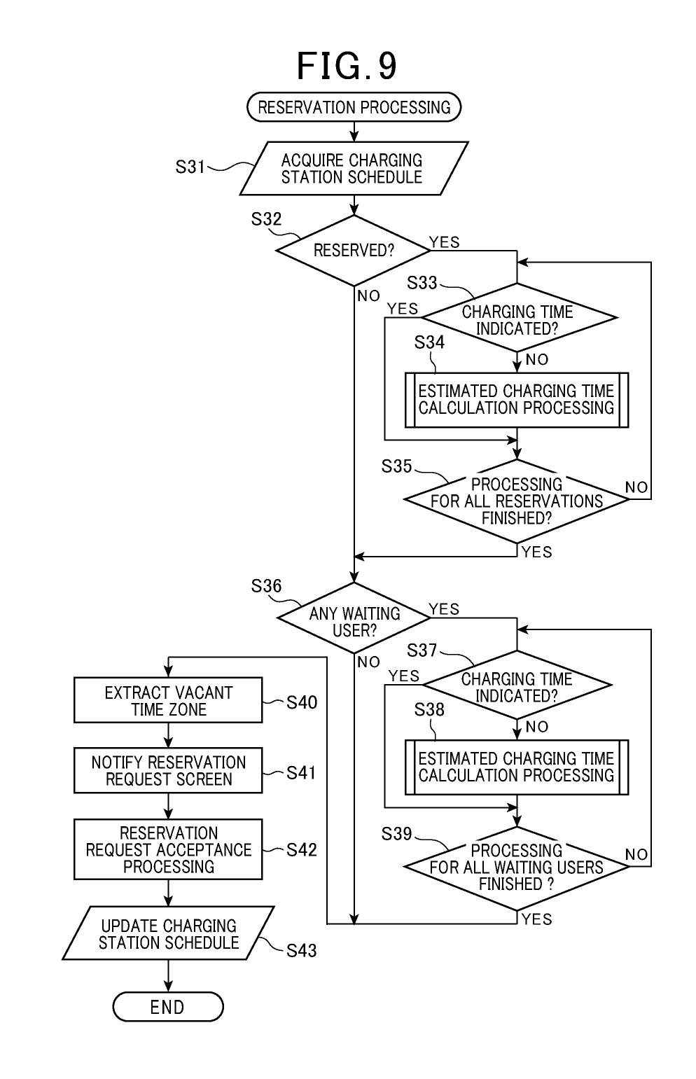

FIG. 9 is a flowchart showing the schedule managing processing in the reservation processing.

The managing server 12 which receives the reservation request acquires the charging schedule of a charging station as a reservation target corresponding to the reservation request (or the charging schedule of each charger 24 of the charging station 11 concerned) from the station information data base 51 (step S31).

Subsequently, the managing server 12 determines on the basis of the acquired charging schedule of the charging station 11 as the reservation target whether there is any reservation before a reservation desired time input to the reservation desired time input column 15E on a reservation desired date input to the reservation desired date input column 15D (step S32).

When it is determined in step S32 that there is some reservation (step S32; Yes), it is determined whether the user indicates (specifies) the desired charging time for the reservation corresponding to the reservation request concerned (step S33).

When it is determined in step S33 that the user indicates the desired charging time (step S33; Yes), the processing is shifted to step S35. When it is determined in step S33 that the user indicates no desired charging time (step S33; No), the estimated charging time calculation processing for calculating an estimated charging time is executed (step S34).

Here, the estimated charging time calculation processing will be described.

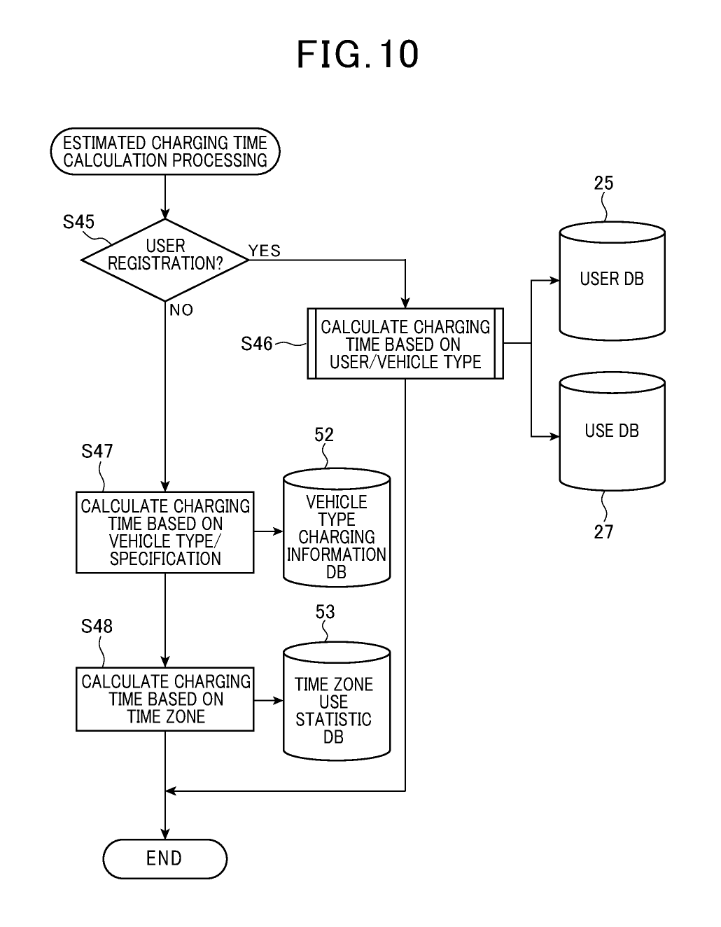

FIG. 10 is a flowchart showing the estimated charging time calculation processing.

First, the managing server 12 determines whether the reservation concerned is a reservation of a registered user (step S45). When it is determined in step S45 that the user concerned has been registered (step S45; Yes), the charging time based on the user and the vehicle type is calculated (step S46).

Specifically, the managing server 12 refers to the user data base 25 to grasp the capacity, type and number of in-vehicle mount batteries mounted in a vehicle which the user wants to charge. With respect to these information, when the vehicle type (grade, specification) is determined, the capacity, type, number of mounted batteries are normally determined. Therefore, these information is determined in accordance with the vehicle type.

It is known that the time required to charge the in-vehicle mount battery greatly varies in accordance with the charging state, degradation level of the battery. For example, with respect to aging degradation, the capacity is reduced to about 70% in ten years, and thus the time required for charging greatly varies.

Furthermore, when the actual capacity (residual capacity) of the battery is large, the charging time is relatively short. When the actual capacity (residual capacity) of the battery is small, the charging time is relatively long.

Therefore, in this embodiment, charging conditions when the registered user concerned previously used charging stations are subjected to statistical processing to acquire use statistic data, and the thus-acquired use statistic data are stored in the use data base 27. The determination of the charging time based on the vehicle type is corrected by referring to the use data base 27. For example, when the aging degradation is considered, the time required for charging is corrected by using a movement average value of the battery capacity.

That is, there is some user's tendency in battery charging situation (battery charging state, day of the week, time zone, season, weather), and thus some tendency is found out in estimated error corresponding to the difference between an actual charging time and an estimated charging time in each case, and thus the estimated charging time can be more accurately calculated by using the use statistic data.

Specifically, an estimated residual amount of a battery under some condition (time zone, day of the week, season, weather) is calculated every registered user, and an estimated charging time when the battery is charged according to a charging method (charging pattern based on settings such as charging current, charging voltage, etc.) specified on the basis of the vehicle type of the registered user concerned is calculated.

First, the time zone will be described. There is a tendency that the charging time required in a time zone which each registered user normally uses (hereinafter referred to as “normally used time zone”) and the charging time required in a time zone which each registered user does not use are different from each other.

It is expected that each registered user charges his/her battery in good time in the normally used time zone and thus the residual amount of the battery has substantially the same tendency every registered user. For example, there exist various registered users such as registered users who have a tendency of charging batteries at an early stage, registered users who have a tendency of waiting for charging until the residual amount of the battery is about to lack, etc. However, when considered from each registered user's side, the user's determination as to whether charging should be performed or not is not substantially varied.

Likewise, with respect to a day of the week, for a registered user who charges his/her battery only once a week, it is estimated that the battery has substantially the same residual charging amount on the same day of the week. However, on a day of the week on which the registered user do not normally charge his/her battery, it is estimated that the residual charging amount of the battery may be smaller than usual. Furthermore, with respect to days of the week such as Saturday and Sunday on which the traffic may get heavy, it is estimated that power consumption increases and the estimated charging time is longer, and thus the estimated charging time is increased by 5%.

Furthermore, with respect to the time zone, lights containing headlights are turned during the hours of darkness or power consumption increases in a traffic jam time zone, and thus it is estimated that the estimated charging time is longer. Therefore, the estimated charging time is increased by 5%.

With respect to the season, in the case of an electric vehicle, the power consumption is larger than usual in a season where an air conditioner (cooler, heater) or the like is used. Therefore, there is a tendency that the battery residual amount under charging is also smaller as compared with a case where no air conditioner is used although the frequency of charging increases. Therefore, it is necessary to estimate the charging time in consideration of these tendencies. More specifically, in winter, the battery residual amount is smaller because of use of a heater, and thus the estimated charging time is estimated to be longer, so that the estimated charging time is increased by 20%, for example. In summer, the battery residual amount is also smaller because of use of a cooler, and thus the estimated charging time is also estimated to be longer, so that the estimated charging time is also increased by 10%, for example.

With respect to the weather, it would be necessary to use a wiper in case of rain or the like, and thus it is expected that the estimated charging time is longer. Therefore, the estimated charging time is increased by 5%, for example.

Furthermore, when considered from the available charging station side, the battery residual amount and the charging time greatly vary in accordance with the location of the charging station and the type of the charger installed in the charging station.

With respect to the location of the charging station, when the user (the user's vehicle) is located at a sightseeing place, it is considered that the user have driven a great distance, and thus there is a tendency that the battery residual amount is smaller as compared with a case where the user (the user's vehicle) is located in an urban area. Furthermore, in such a case that the charging station is located on a hill, there is a tendency that the battery residual amount is smaller as compared with a case where the charging station is located at a flat place.

Furthermore, the charging time itself varies simply in accordance with whether the type of the installed charger is a fast charger or a normal charger.

Accordingly, the use statistic data are stored in the user data base 27 while classified (grouped) in accordance with the time zone, the day of the week, the season, the location of the charging station, the type of the installed charger, etc., whereby the charging time can be more accurately estimated.

In this case, the estimated charging time calculated on the basis of only the condition caused by the user's tendency (battery charging state, day of the week, time zone, season) and the estimated charging time calculated on the basis of only the condition caused by the charging station (location, the type of installed charger) may be separately calculated, and predetermined weighting coefficients may be applied to both the estimated charging times to calculate an estimated charging time. In this case, the estimated charging time calculated on the basis of only the condition caused by the user's tendency, the estimated charging time calculated on the basis of only the condition caused by the charging station and the charting time taken for actual charging are compared with one another, and the weighting coefficient for the estimated charging time which is more approximate to the actual charging time is increased, whereby the charging time can be more accurately estimated. For example, in an initial state, the weighting coefficients for the estimated charging time calculated on the basis of only the condition caused by the user's tendency and the estimated charging time calculated on the basis of only the condition caused by the charging station are set to 50:50. When as a subsequent data collection result it is found that the estimated charging time calculated on the basis of only the condition caused by the charging station is nearer to the actual charging time, the weighting coefficient for the estimated charging time calculated on the basis of only the condition caused by the charging station is increased (for example, the ratio of the weighting coefficients is changed to 25:75).

When it is determined in step S45 that user registration is not performed (step S45; No), the charging time calculation (charting time estimation) based on the vehicle type/specification, the location of the charging station, the type of the installed charger, etc. is performed by referring to the vehicle type charging information data base 52 (step S47).

Specifically, the number, capacity and type of batteries mounted in a vehicle as a target are determined on the basis of the vehicle type/specification, and also estimation of the number of using years, etc. can be estimated. Therefore, the standard charging time of the battery concerned is calculated. The calculated charging time is corrected on the basis of the location of the charging station and the type of the installed charger.

That is, the standard charging time is determined on the basis of the number, capacity and type of batteries by referring to the vehicle type charging information data base 52, degradation is considered on the basis of the estimated number of use years, and further the estimated charging time is calculated on the basis of the location of the charging station and the type of the installed charger.

In this case, when only the vehicle type and the specification are known, the standard charging time which is acquired by referring to the vehicle type charging information database 52 is readout in place of the calculation of the charging time.

Subsequently, the managing server 12 corrects the charging time calculated in step S47 in consideration of the average charging time of each time zone to calculate the estimated charging time more accurately (step S48), and then shifts the processing to step S35.

The managing server 22 determines whether the processing for all the reservations is finished or not (step S35).

When it is determined in step S35 that the processing for all the reservations has not yet been finished (step S35; No), the managing server 12 shifts the processing to step S33 again to execute the same processing as described above, whereby the estimated charging time calculation processing is executed for all the reservations for which no charging time is indicated (step S34).

When it is determined in step S32 that there is no reservation (step S32; No), or when it is determined in step S35 that the estimated charging time calculation processing for all the reservations has been finished (step S35; Yes), the managing server 12 determines on the basis of the acquired charging schedule of the charging station 11 as the reservation target whether there is any user waiting for charging on a reservation desired date input to the reservation desired date input column (step S36). Actually, a user waiting for charging exists only when the reservation desired date is the current day, and thus no user waiting for charging exists when the reservation desired date is a day other than the current day. Therefore, the determination of the step S36 is “NO” at all times.

When there is any user waiting for charging in the determination step of S35 (step S36; Yes), it is determined whether the user waiting for charging indicates a desired charging time (step S37).

When it is determined in step S37 that the user waiting for charging indicates a desired charging time (step S37; Yes), the processing is shifted to step S39.

When it is determined in step S37 that the user waiting for charging does not specify any desired charging time (step S33; No), the estimated charging time calculation processing for calculating the estimated charging time is executed for the user waiting for charging (step S38).

Subsequently, the managing server 12 determines whether the processing for all the users waiting for charging is finished or not (step S39).

When it is determined in step S39 that the processing for all the users waiting for charging has not yet been finished (step S39; No), the managing server 12 shifts the processing to the step S37 again to execute the same processing, and the estimated charging time calculation processing is executed for all the charging waiting users who do not indicate (specify) any desired charging time (step S38).

When it is determined in step S36 that there is no user waiting for charging (step S36; No) or when it is determined in step S39 that the estimated charging time calculation processing for all the users waiting for charging is finished (step S39, Yes), the managing server 12 executes the processing of extracting a vacant time zone (step S40). Subsequently, the managing server 123 notifies and displays a reservation request screen (step S41).

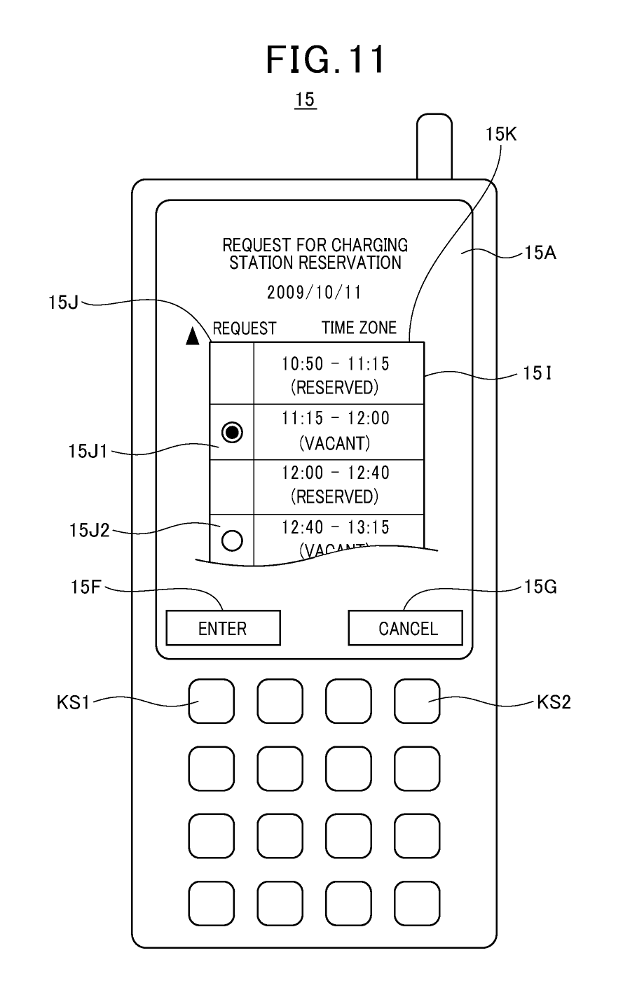

FIG. 11 is a diagram showing an example of the reservation request screen.

The display screen 15A of the portable telephone terminal 15 has a time schedule display selecting column display portion 15I on which a reservation time schedule of a desired charging station on a reservation desired date (in this embodiment, Oct. 11, 2009) is displayed. In this time schedule display selecting column display unit 15I, the reservation time schedule can be scrolled in the vertical direction, and it is scrolled in a desired direction by a scroll key (not shown) of the portable telephone terminal 15 (for example, numeral keys “2” and “8” disposed in the vertical direction).

Specifically, in the case of the example of FIG. 11, the time schedule display selecting column display portion 15 is provided with a request check column 15J and a time zone display column 15K, and information concerning plural time zones is displayed on the time schedule display selecting column display portion 15. In the case of FIG. 11, a time zone “10:50-11:15” is under a reserved state, a time zone “11:15-12:00” is under a vacant state, a time zone “12:00-12:40” is under a reserved state, and a time zone “12:40-13:15” is under a vacant state.

In this case, check boxes are displayed on the request check columns 15J1 and 15J2 corresponding to the vacant state, and the user selects the request check column corresponding to a time zone in which the user wants to make a reservation, and operates the key switch KS1 so as to set the selected check column to a check state (in the case of FIG. 11, sets the request check column 15J1 to the selected state “”).

Accordingly, the reservation request content is settled, and the reservation request is transmitted to the managing server 12 side. The managing server 12 executes the reservation request acceptance processing (step S42). Accordingly, the managing server 12 updates the charging schedule of the charging station 11 as a reservation target in the station information data base 51, and then finishes the reservation processing (step S27).

In the charging waiting processing, the same processing is executed. Furthermore, an acceptance result notification representing an acceptance result based on the reservation processing (step S27) or the charging waiting processing (step S28) is transmitted to the portable telephone terminal 15 (step S29).

Accordingly, the charging station reservation completion screen as the acceptance result screen is displayed on the display screen of the portable telephone terminal 15 (step S30).

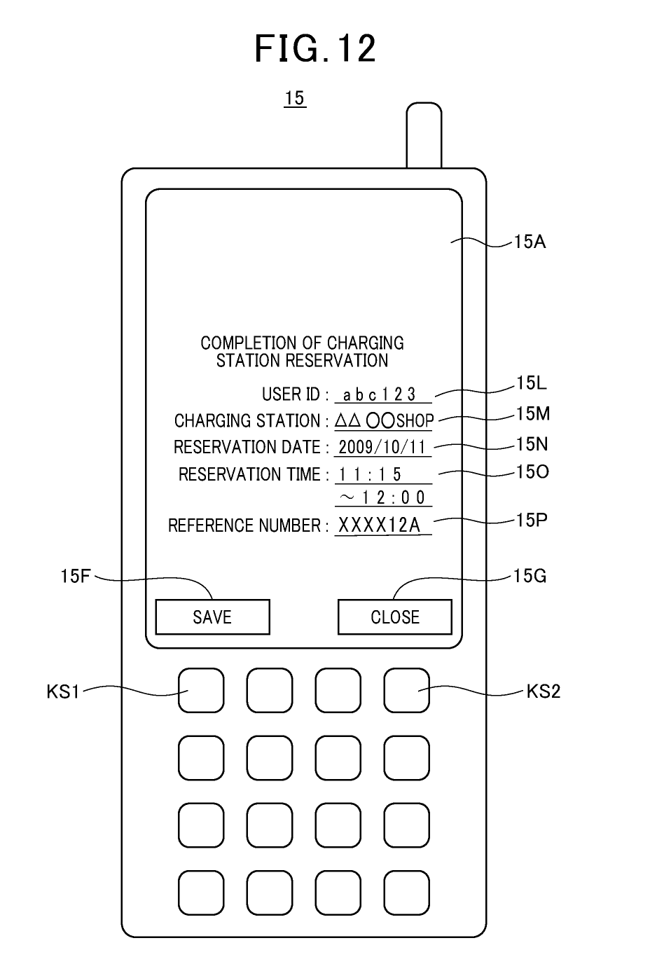

FIG. 12 is a diagram showing an example of the charging station reservation completion screen as an acceptance result screen.

As shown in FIG. 12, the display screen 15A of the portable telephone terminal 15 has a user ID display column 15L, a charging station display column 15M, a reservation date display column 15N, a reservation time display column 15O, a reservation reference number display column 15P, a first operation content display portion 15F representing that the operation of the key switch KS1 is an instruction for saving the display screen 15A (reservation content), and a second operation content display portion 15G representing that the operation of the key switch KS2 is an instruction of finishing the processing without saving the display screen 15A (reservation content).

Specifically, in the case of an example of FIG. 12, the user ID is “abc123”, the reserved charging station is “ΔΔ ◯◯ shop”, the reserved date is “Oct. 11, 2009”, the reserved time (reserved time zone) is “11:15-12:00”, and the reservation reference number is “XXXX12A”.

Accordingly, the user goes to the charging station “ΔΔ ◯◯ shop” by 15 minutes past eleven o'clock on Oct. 11, 2009, indicates the reservation reference number “XXXX12A” and applies for use of the charging station, whereby the user is allowed to immediately use the charging station. Therefore, the waiting time at the charging station concerned can be remarkably reduced, and also the user can charge his/her battery surely.

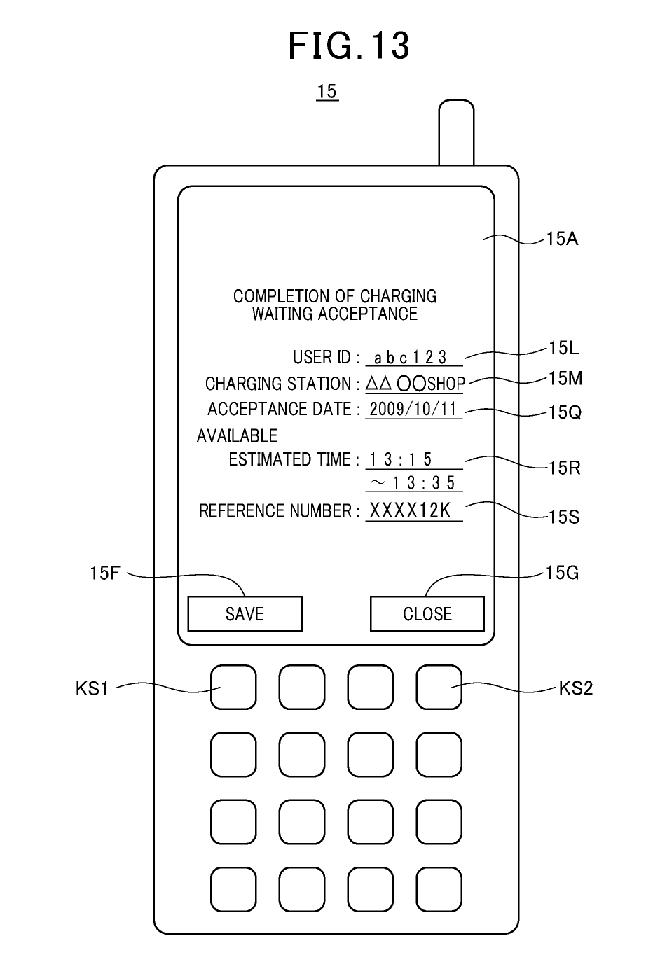

FIG. 13 is a diagram showing an example of the charging waiting acceptance completion screen as an acceptance result screen.

As shown in FIG. 13, the display screen 15A of the portable telephone terminal 15 has a user ID display column 15L, a charging station display column 15M, an acceptance date display column 15Q, an available estimated time display column 15R, a charging waiting reference number display column 15S, a first operation content display portion 15F representing that the operation of the key switch KS1 is an instruction of saving the display screen 15A (the content of charging waiting), and a second operation content display portion 15G representing that the operation of the key switch KS2 is an instruction of finishing the processing without saving the display screen 15A (the content of charging waiting).

Specifically, in the case of the example shown in FIG. 13, the user ID is “abc123”, the reserved charging station is “ΔΔ ◯◯ shop”, the acceptance date is “Oct. 11, 2009”, the available estimated time (available estimated time zone) of the charger of the charging station is “13:15-13:35”, and the charging waiting reference number is “XXXX12K”.

Accordingly, the user goes to the charging station “ΔΔ ◯◯ shop” by 15 minutes past thirteen o'clock on Oct. 11, 2009, indicates the reservation reference number “XXXX12K” and applies for use of the charging station, whereby the user is allowed to immediately use the charging station. Therefore, the waiting time at the charging station concerned can be remarkably reduced, and also the user can charge his/her battery surely.

The foregoing description relates to the processing before charging is started. Upon reception of a notification from the controller 21, the managing server 12 transmits a notification mail concerning a charging completion estimated time to the mail address corresponding to the portable telephone terminal 15 or PC terminal of the user who is charging his/her battery (batteries) so that the charger 24 of the charging station is released to others immediately after the charging is finished, and also transmits a charging completion notification mail when the charging has been finished.

Thereafter, the controller 21 of the charger 24 notifies to the managing server 12 at the time point when charging can be started, that is, when a predetermined time elapses after the user who charges the battery (batteries) pulls out the charging connector 20 from the vehicle or at the time point when the user makes an instruction of releasing the charger 24 through the operation panel 22. The managing server 12 checks the waiting condition and the reservation condition of the charging station 11. When the charging schedule can be advanced (moved forward), a notification mail representing that the charger 24 can be used with moving forward (hereinafter referred to as “advanced use”) is transmitted to the main address corresponding to the portable telephone terminal 15 (or PC terminal) of a user to who advanced use is allowed. When no main address is registered, this processing is not executed.

Next, the charging waiting processing described above (step S28) will be described in detail.

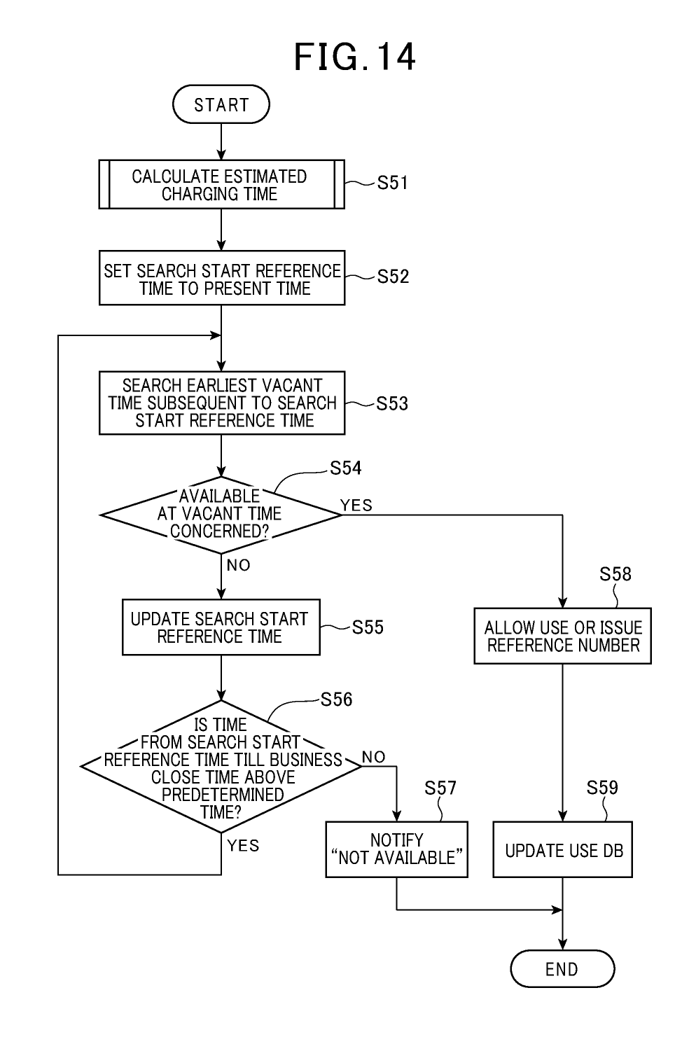

FIG. 14 is a flowchart showing the charging waiting processing.

First, when there is a request for waiting for charging, the managing server 12 refers to the use statistic DB 54 of the user DB 27 on the basis of the user ID of a user who makes this request, and estimates a charging time TC according to the above procedure on the basis of past charger using data of the user concerned (step S51).

Subsequently, the managing server 12 sets the search start reference time to the time at which the charging request is made (present time) (step S52).

Subsequently, the managing server 12 acquires the charging schedule of the charging station 11 concerned (every charger 24) from the station information data base 51, and searches a vacant time in the earliest time zone subsequent to the search start reference time (step S53).

On the basis of whether the length of the vacant time exceeds the charging time TC acquired in step S51, the managing server 12 determines whether the charger is available at the vacant time concerned (step S54).

When it is determined in step S54 that the charger is available at the vacant time concerned (step S54; Yes), the managing server 12 immediately notifies an acceptance result containing allowance of use, and when the charger is available after a predetermined time, the managing server 12 notifies an acceptance result containing a time at which the charger can be used and a charging waiting reference number (step S58). Furthermore, the managing server 12 updates the use DB 27 and then finishes the processing (step S59).

When it is determined in step S54 that the charger is not available at the vacant time concerned (step S54; No), the managing server 12 updates the search start reference time to the end time of the vacant time (step S55).

Subsequently, the managing server 12 determines whether there is a predetermined time or more between the search start reference time after the update and the business close time of the charging station concerned (step S56). In this case, the predetermined time is properly determined in consideration of a situation that a cleanup work is completed at the charging station side at the close of business after the user completes the charging and goes away from the charging station concerned. When the charging station is open for 24 hours, it is unnecessary to provide this step S56.

When it is determined in step S56 that the time from the search start reference time after the update till the business close time of the charging station concerned is equal to the predetermined time or more (step S56; Yes), the managing server 12 shifts the processing to the step S53 to repeat the same processing again.

When it is determined in step S56 that the time from the search start reference time after the update till the business close time of the charging station concerned is less than the predetermined time (step S56; No), the managing server 12 transmits a non-available notification indicating that there is no available charging station on the date concerned, and finishes the processing (step S57).

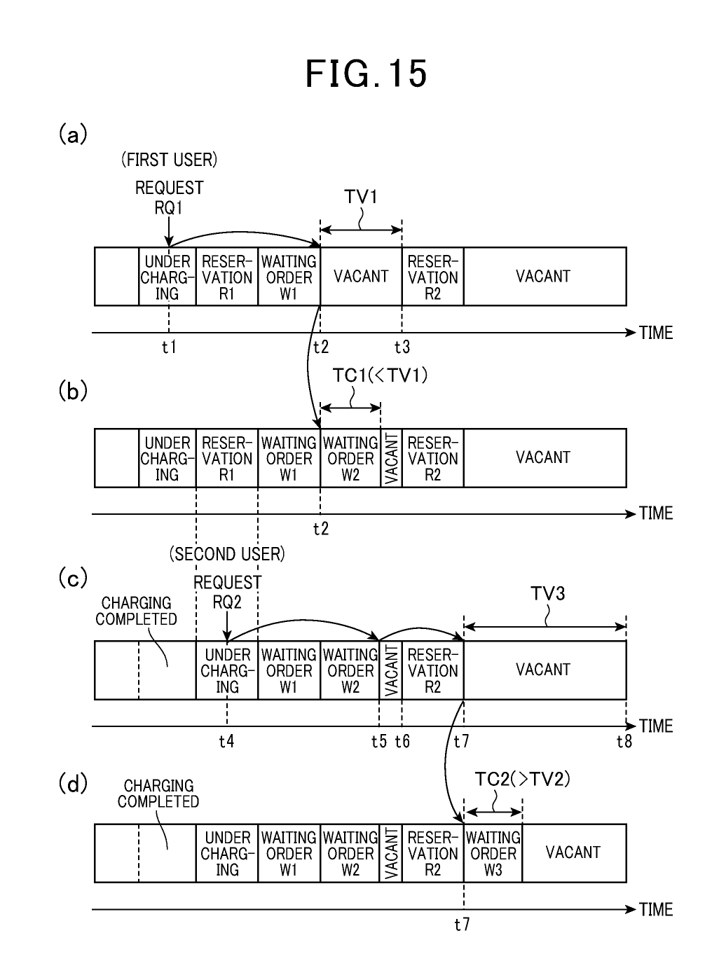

FIG. 15 is a diagram showing the charging waiting processing.

The specific charging waiting processing will be described with reference to FIG. 15. In the following description, the processing step numbers of the flowchart of FIG. 14 are referred to.

First, a case where a first user makes a charging waiting request RQ1 at a time t1 as shown at the uppermost stage (a) of FIG. 15 will be described.

At the time t1, the charger is under a charging state at the time point when the first user makes the request RQ1, and thus the charger is under the state that it cannot be immediately used by the first user.

Accordingly, the managing server 12 refers to past charger using data of the first user on the basis of the user ID of the user concerned, and calculates an estimated charging time TC1 (see the second stage (b) (below the stage (a)) of FIG. 15) (step S51).

Subsequently, the search start reference time is set to the time t1 at which the request for charging is made (step S52). Subsequently, the managing server 12 searches a vacant time in the earliest time zone subsequent to the time t1 (=search start reference time) (step S53).

Specifically, the vacant time (from time t2 to time t3) starting from the time t2 is searched. In this case, the length TV1 (=t3−t2) of the vacant time exceeds the charging time TC1, and thus the managing server 12 determines that the charger is available at the vacant time concerned (step S54; Yes). Therefore, the managing server 12 notifies an acceptance result containing a use start allowance time (=t2) and a charging waiting reference number as a waiting order W2 (step S58). Thereafter, the managing server 12 updates the station information data base 51 of the use DB 27, and finishes the processing (step S59).

Next, a case where a second user makes a charging waiting request RQ2 at a time t4 after the first user makes the charging waiting request as shown at the third stage (c) (below the second stage (b)) of FIG. 15 will be described.

At the time t4, the charger is under charging by another user corresponding to a reservation R1 at the time point when the second user makes the request RQ2, and thus the charger is under the state that it cannot be immediately used by the second user.

Accordingly, the managing server 12 refers to the past charger using data of the second user on the basis of the user ID of the second user, and estimates a charging time TC2 (see the lowest stage (d) of FIG. 15) according to the above procedure (step S51).

Subsequently, the managing server 12 sets the search start reference time to the time t4 at which the second user makes the request for charging (step S52).

Subsequently, the managing server 12 searches a vacant time in the earliest time zone subsequent to the time t4 (=search start reference time) (step S53).

Specifically, a vacant time (from time t5 to time t6) starting from the time t5 is searched. In this case, the length TV2 (time t6−time t5) of the vacant time is less than the calculated charging time TC2, and thus the second user cannot use the charger at the vacant time concerned (step S54; No). Accordingly, the managing server 12 updates the search start reference time to the time t6 at which the vacant time concerned is ended.

Subsequently, the managing server 12 determines whether the time from the search start reference time t6 after the update till the business close time is equal to a predetermined time or more (step S56). In this case, the time from the search start reference time t6 after the update till the business close time is equal to the predetermined time or more, and thus the managing server 12 shifts the processing to the step S53.

Subsequently, the managing server 12 searches a vacant time in the earliest time zone subsequent to the time t6 (=search start reference time) (step S53). Specifically, a vacant time (from time t7 to time t8) starting the time t7 is searched. In this case, the length TV3 (=t8−t7) of the vacant time exceeds the calculated charging time TC2. Therefore, the managing server 12 determines that the second user can use the charger at the vacant time concerned (step S54; Yes), and notifies an acceptance result containing the use start allowance time (=t7) and the charging waiting reference number as a waiting order W3 (step S58). Thereafter, the managing server 12 updates the station information data base 51 of the use DB 27 and finishes the processing (step S59).

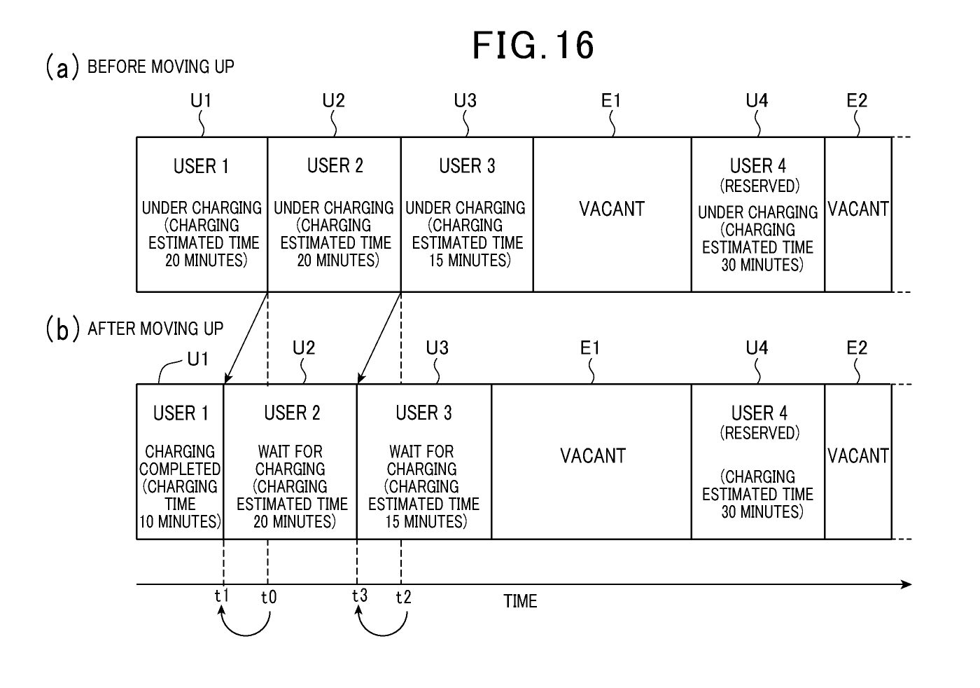

FIG. 16 shows an example of the charging schedule of the charger in the charging station.

Specifically, the charging schedule stored in the station information data base 51 is shown in FIG. 15.

It is assumed that when three users U1, U2 and U3 sequentially wait for charging as shown in FIG. 16, the initial estimated charging time of the user U1 is set to 20 minutes (see the upper stage (a) of FIG. 16), but the actual charging time is equal to 10 minutes. In this case, the managing server 12 transmits to the user U2 a notification mail indicating that the charging start scheduled time of the user U2 is changed from a time tb to a time t1 as shown in the lower stage (b) of FIG. 16. Likewise, the managing server 12 transmits to the user U3 a notification mail indicating that the charging start scheduled time of the user U3 is changed from a time t2 to a time t3 as shown in (b) of FIG. 16. With respect to the user U4 who does not wait for charging, but has a reservation, the managing server 12 does not change the charging start scheduled time insofar as there is no request from the user 4.

In this case, the vacant time E1 can be lengthened most greatly under the following condition, and other user's reservations are liable to be acceptable.

$$\begin{matrix}t 0 - t 1 = t 2 - t 3 \\ = 10 minutes ( \begin{matrix}= the time by which the actual charging \\ time is reduced\end{matrix} )\end{matrix}$$

However, when the actual charging time is excessively shortened, the charging start time for the next user is remarkably early, and thus there is a risk that the managing server 12 cannot deal with such a situation. Therefore, the upper limit value (advance maximum time) maybe determined for the advanced use in advance. For example, when the advance maximum time is set to 15 minutes in advance, each user waiting for charging can take an action in consideration of this condition. Therefore, the operation of the charging stations 11 can be performed more efficiently.

Furthermore, conversely when there is a risk that the actual charging time is postponed (moved down), a notification main indicating that the charging start scheduled time is changed for postpone is likewise transmitted to a user.

In this case, the upper limit value (postpone maximum time) is settled with respect to the postpone, and when there is a probability that the charging time exceeds this postpone maximum time, the current charging of the user may be interrupted. Accordingly, there can be prevented occurrence of such a situation that charging has not been completed to the end of time due to deterioration of the battery and thus the charging time is lengthened endlessly. In this case, the charging is interrupted after a notification indicating that the charging cannot be completed due to deterioration or the like is transmitted to a user who charges the battery.

Accordingly, a load caused by a great change of the scheduled charging start time can be prevented from being imposed on subsequent users waiting for charging.

Next, the feedback processing after the charging is completed will be described.

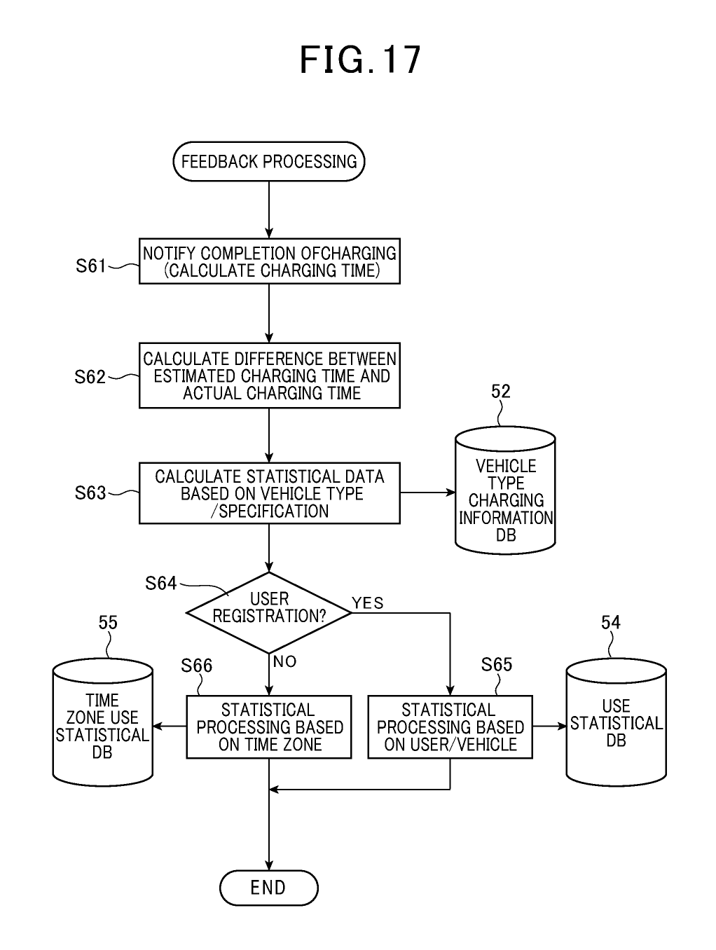

FIG. 17 is a flowchart showing the feedback processing after the charging is completed.

The feedback processing after charging is completed is data updating processing to estimate a charging completion time at the next time, and the estimation precision is enhanced by executing this processing.

As described above, at the time point when charging can be started, that is, at the time point when a predetermined time elapses after a user who has just charged his/her battery pulls out the charging connector 20 from his/her vehicle, or at the time point when a release instruction of the charging station 11 is made through the operation panel 22, the controller 21 of the charger 24 notifies this matter to the managing server 12. In response to this notification, the managing server 12 notifies a charging completion acceptance, and calculates the charging time (step S61).

Subsequently, the managing server 12 calculates the difference (estimation error) between the actual charging time and the estimated charging time which was estimated when the reservation request was made or the charging waiting request was made (step S62). Subsequently, the managing server 12 calculates the statistic data based on the vehicle type, the specification on the basis of the estimation error concerned, and updates the vehicle type charging information data base 52 (step S63). That is, the vehicle type charging information data base 52 is updated while the type, number, capacity (specification), etc. of the vehicle which are determined on the basis of the vehicle type are associated with the average value, the degree of scatter (standard deviation) (step S63).

Subsequently, it is determined whether the user concerned is a registered user or not (step S64).

When it is determined in step S64 that the user is a registered user (step S64; Yes), the estimation error calculated in step S62 is registered in the use statistic data base 54, and also the relationship between the registered user and the average value and degree of scatter (standard deviation) of the charging time of the vehicle, the relationship between the registered user concerned and the average value and the degree of scatter (standard deviation) of the estimation error, etc. are stored in the use statistic data base 54. Furthermore, the statistical processing based on the charging time, the charging timing (season), etc. is executed, and the data of the registered user concerned in the use statistic data base 54 are updated on the basis of the statistic data based on each charging time zone, the charging timing (season) or the like. Thereafter, the processing is finished (step S65).

As a result, the statistic data containing the error between the charging time estimated at present and the actual charging time are acquired, and the charging time is estimated on the basis of new statistic data at the next and subsequent times. Accordingly, this is equivalent to the update of the calculation method of the estimated charging time at the registered user side. Therefore, the estimated charging time can be more accurately calculated at the next and subsequent times.

As described above, as the charging is repeated, the estimation of the charging time is more accurate, and the operation management can be more accurately performed every charging station 11.

When it is determined in step S64 that the user is not a registered user (step S64; No), the use average time of each time zone of one day and the degree of scatter (standard deviation) thereof are subjected to statistical processing with respect to one day, one month, season or the like to update the time zone use information data base 55, and then the processing is finished (step S66).

As described above, according to this embodiment, the estimated charging time is calculated every user who uses the charger 24 of the charging station 11, and the charging waiting time or the charging schedule (timetable) is more accurately set on the basis of the charging estimated times of users who reserve charging or wait for charging prior to some user. Therefore, the operation efficiency of each charging station 11 can be enhanced, and the waiting time of users who are going to charge their batteries is reduced, whereby the user's convenience can be enhanced.

In the foregoing description, users make reservations for charging or request for waiting for charging. However, this embodiment may be configured so that users can acquire using conditions of charging stations by using the operation managing system 10 as described above so that the users grasp the present using conditions of the charging stations 11 and thus use the optimum charging stations 11 for them.

Specifically, as an option which can be set when a charging waiting request as described above is made, not only the using condition of a charging station 11 specified by a user is presented to the user, but also a charging station (s) 11 at which the waiting time is shorter (or shortest) and which is located within a predetermined distance range (or at the shortest distance) from the specified charging station 11 or the present position of the user is presented as a recommended charging station (s) 11 to the user.

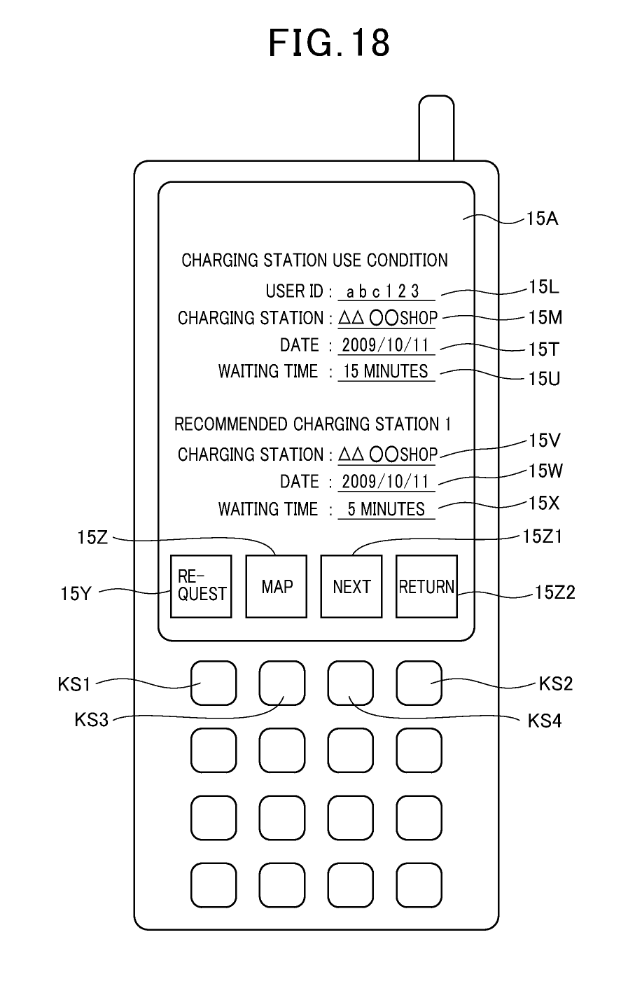

FIG. 18 is a diagram showing an example of the charging station using condition screen.

As shown in FIG. 18, the display screen 15A of the portable telephone terminal 15 has a user ID display column 15L for displaying user ID, a charging station display column 15M for displaying a charging station name specified by the user, a date display column 15T for displaying a date on which the user inquires about a charging station using condition, a waiting time display column 15U for displaying a waiting time at the charging station displayed on the charging station display column 15M, a charging station display column 15V for displaying a charging station name of a recommended charging station, a date display column 15W for displaying a date on which the user inquires about a charging station using condition, and a waiting time display column 15X for displaying a waiting time of the charging station displayed on the charging station display column 15V.

Furthermore, the display screen 15A of the portable telephone terminal 15 contains a first operation content display portion 15Y representing that under the state that any one of the charging stations displayed on the display screen 15A is selected and specified by up and down cursor keys (not shown) (for example, numeral keys “2” and “8” arranged in the vertical direction), the operation of the key switch KS1 is an instruction of a charging waiting request of the specified charging station, a second operation content display portion 15Z representing that under the state that any one of the charging stations displayed on the display screen 15A is selected and specified by up and down cursor keys (not shown) (for example, numeral keys “2” and “8” arranged in the vertical direction), the operation of the key switch KS3 is an instruction of displaying a map of the specified charging station 11, a third operation content display portion 15Z1 representing that the operation of the key switch KS4 is an instruction of moving the cursor to the next item, and a fourth operation content display portion 15Z2 representing that the operation of the key switch KS2 is an instruction of moving the cursor to the preceding item.

Specifically, in the case of FIG. 17, it is shown that the user ID is “abc123”, the charting station specified as the charging waiting target is “ΔΔ ◯◯ shop”, the date on which the charging station using condition is inquired about is “Oct. 11, 2009”, and the waiting time of the specified charging station is “15 minutes” at present.

Furthermore, it is shown that the first recommended charging station is “ΔΔ ∇□ shop”, the date on which the charging station using condition is inquired about is “Oct. 11, 2009”, and the waiting time of the specified charging station is “5 minutes” at present.

As described above, not only the specified charging station 11 whose using condition is inquired about, but also the recommended charging station which is shorter in waiting time and located within a predetermined distance range from the specified charging station 11 or the present position of the user is presented to the user. Therefore, when the charging stations are used, the selection range for uses can be widened, and the convenience for users can be enhanced.

Furthermore, when viewed from the managing server 12 side, the overall use efficiency of the plural charging stations can be enhanced, and thus the plural charging stations can be efficiently operated. Still furthermore, actually used charging stations are not uneven in using condition. For example, in such a case that the using condition exceeds the capacity of a specific charging station and thus a new charging station is installed, a place at which a new charging station should be installed can be determined.

In this case, users can beforehand specify how shorter the waiting times at charging stations to be recommended should be than the waiting time at the specified charging station 11 (i.e., the users can specify the time range by which the waiting times of the recommended charging stations is shortened as compared with the waiting time of the specified charging station) or how far charging stations to be recommended should be away from the specified charging station 11 or the present position of the user (i.e., the users can specify the distance range within which the charging stations to be recommended are located from the specified charging station 11 or the present position of the user).

Next, another processing of making a reservation request will be described.

In the foregoing description, a time schedule is notified to a user when the user makes a reservation request, and the user selects a desired time zone. This processing is the processing of making a reservation request when the managing server 12 automatically selects a reserved time zone.

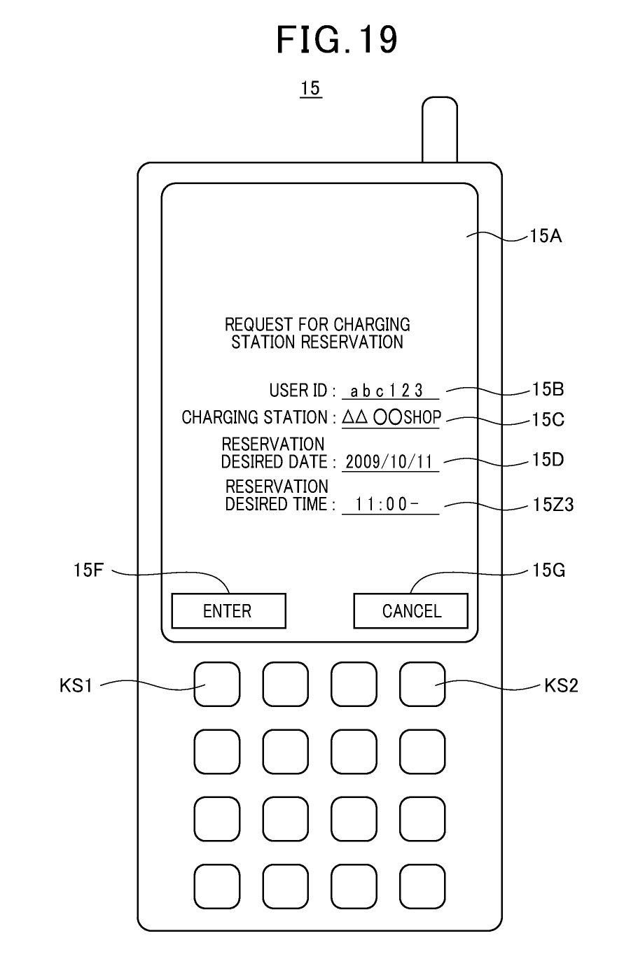

FIG. 19 is a diagram showing an example of the reservation request screen.

The display screen 15A of the portable telephone terminal 15 contains a user ID input column 15B, a charging station specifying (indicating) column 15C, a reservation desired date input column 15D, a reservation desired time input column 15Z3, a first operation content display portion 15F representing that the operation of the key switch KS1 is an instruction of settling the content of the reservation request or the content being currently input, and a second operation content display portion 15G representing that the operation of the key switch KS2 is an instruction of cancelling the content of the reservation request or the content being currently input.

Specifically, in the case of the example of FIG. 19, the user ID is “abc123”, the reservation desired charging station is “ΔΔ ◯◯ shop”, the reservation desired date is “Oct. 11, 2009” and the reservation desired time is “11:00 or later”.

With respect to the reservation desired time, a time zone like “11:00-12:00” may be specified, or the last time of the reservation start time like “−11:00” (11:00 or earlier) may be specified. Furthermore, not only the charging start time, but also the estimated charging end time maybe likewise specified.

When the user completes input of the reservation request screen, the user checks the content thereof and then operates the key switch KS1. Accordingly, the reservation request content is settled, and the acceptance request corresponding to the reservation request is transmitted to the managing server 12.

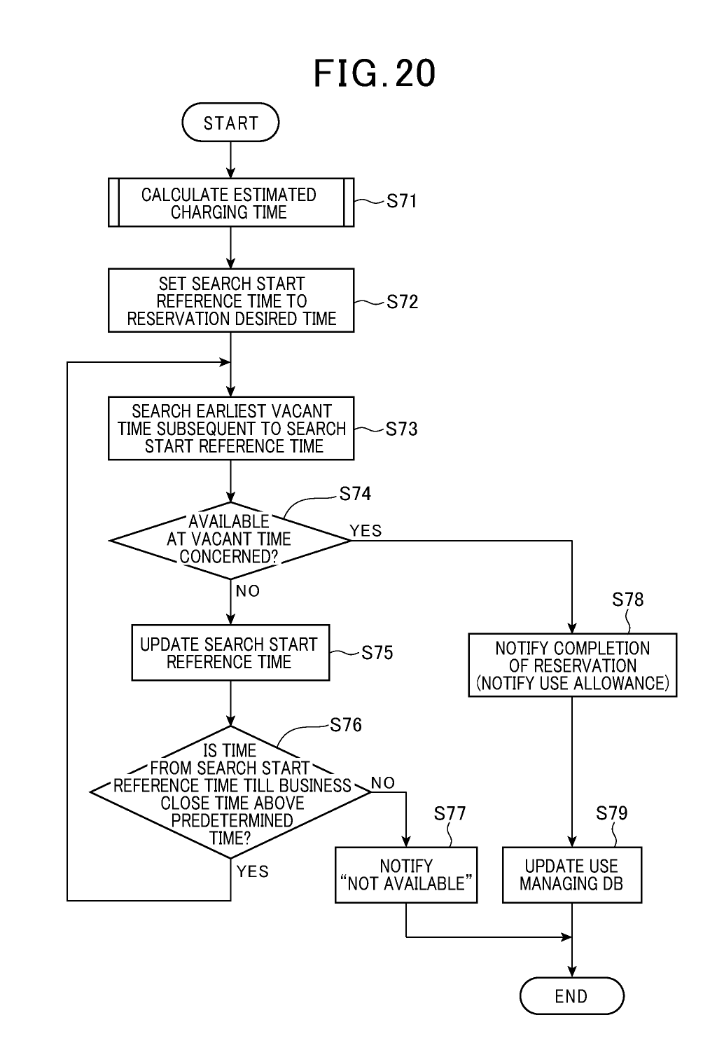

FIG. 20 is a flowchart showing the reservation processing.

The managing server 12 which receives the reservation request estimates (calculates) the charging time TC according to the procedure described above on the basis of the user's past charger using data based on the user ID of the user who made the request (step S71).

Subsequently, the managing server 12 sets the search start reference time to the reservation desired time (step S72).

Subsequently, the managing server 12 searches a vacant time in the earliest time zone subsequent to the search start reference time on the basis of the charging schedule of the charging station 11 (or the charging schedule of each charger 24 of the charging station 11) (step S73).

Specifically, the managing server 12 receiving the reservation request acquires the charging schedule of the charging station 11 as the reservation target corresponding to the reservation request (or the charging schedule of each charger 24 of the charging station 11 concerned) from the station information data base 51, and searches a vacant time according to the same procedure of the steps S32 to S39 of FIG. 9.

Then, on the basis of a determination as to whether the length of the searched vacant time exceeds the charging time TC determined in step S71, the managing server 12 determines whether the charger is available at the vacant time concerned (step S74).

When it is determined in step S74 that the charger is available at the vacant time concerned (step S74; Yes), the managing server 12 makes a reservation completion notification containing the reserved time (reserved time zone) and the reservation reference number as shown in FIG. 12 (step S78). Then, the managing server 12 updates the use DB 27, and finishes the processing (step S79).

When it is determined in step S74 that the charger is not available at the vacant time concerned (step S74; No), the managing server 12 updates the search start reference time to the end time of the vacant time concerned (step S75).

Subsequently, the managing server 12 determines whether the time from the search start reference time after the update till the business close time of the charging station is equal to a predetermined time or more (step S76).

In this case, the predetermined time is properly determined in consideration of a situation that a cleanup work is completed at the charging station side at the close of business after the user completes the charging and goes away from the charging station concerned. When the charging station is open for 24 hours, it is unnecessary to provide this step S76.

When it is determined in step S76 that the time from the search start reference time after the update till the business close time of the charging station is equal to the predetermined time or more (step S76; Yes), the managing server 12 shifts to the step S73 to repeat the same processing.

When it is determined in step S73 that the time from the search start reference time after the update till the business close time of the charging station is not equal to the predetermined time or more (step S76; No), the managing server 12 transmits a “not available” notification indicating that no charging station is available on the day, and finishes the processing (step S77).

As described above, according to the reservation request processing described above, the managing server 12 can automatically select the reserved time zone, and thus the labor can be omitted from the user.

What is claimed is:

1. An operation managing server for charging stations each of which has a charger and accepts a charging request for charging a vehicle battery of a user through the charger at a charging station, comprising:
a charging request accepting unit that accepts a charging request from a user when the user makes the charging request; and
a charging time estimating unit that estimates a charging time required to charge the vehicle battery of the user on the basis of past charger using data of the user, wherein when there is any charging request from a next user, the charging request accepting unit accepts the charging request concerned while reflecting the estimated charging time of the former user.

2. The operation managing server according to claim 1, wherein when there is any charging request from the next user, the charging request accepting unit presents a charging start allowance time to the next user on the basis of the estimated charging time and accepts the charging request from the next user.

3. The operation managing server according to claim 2, wherein when the charging request accepting unit accepts a charging request containing a charging station which is selected and specified from plural charging stations by a user, the charging time estimating unit calculates waiting times of the user at the plural charging stations and presents a charging station bringing a shorter waiting time as a recommended charging station to the user.

4. The operation managing server according to claim 3, wherein when the charging request accepting unit accepts the charging request containing the charging station which is selected and specified from the plural charging stations by the user, the charging time estimating unit calculates a distance from each of the plural charging stations to the specified charging station or a present position of the user and presents a charging station located at a shorter distance from the specified charging station or the present position of the user as a recommended charging station to the user.

5. The operation managing server according to claim 1, wherein the charging request is a request for reserving charging.

6. An operation managing system comprising:
a plurality of charging stations each of which has a battery charger for charging a battery of an electric vehicle, and a controller for managing the battery charger; and
a server that accepts a charging request for charging a battery of a user when the user makes the charging request to the server, has a data base for storing past charger using data of the user, and estimates a charging time required to charge the battery of the user on the basis of the past charger using data of the user.

7. The operation managing system according to claim 6, wherein when there is a charging request from a next user, the server accepts the charging request from the next user while reflecting the estimated charging time of the former user.

8. The operation managing system according to claim 6, wherein the charging request is a request for reserving charging.
